(19) United States
(12) Patent Application Publication
(10) Pub. No.: US 2019/0205935 A1
(43) Pub. Date: Jul. 4, 2019

(54) System and Methods of Delivering Targeted Content Through Digital Signages

(71) Applicant: Lexmark International, Inc., Lexington, KY (US)

(72) Inventor: Kevin James Albrecht, Shawnee, KS (US)

(21) Appl. No.: 15/856,676

(22) Filed: Dec. 28, 2017

(51) Int. Cl. G06Q 30/02; H04L 12/26; H04L 29/08

(52) U.S. Cl. CPC G06Q 30/0261; H04L 29/08225; H04L 43/08

(57) ABSTRACT

Methods for delivering targeted advertising content to an audience of one or more digital signages are disclosed. One example method includes receiving a network access request from a user of a client device located in a vicinity of the one or more digital signages; requesting permission from the user of the client device to retrieve data from the client device; upon receiving the permission from the user, retrieving the data from the client device; transmitting the data retrieved from the client device to an advertising server for determining one or more advertising content based on the data retrieved from the client device; receiving the one or more advertising content from the advertising server; and displaying the one or more advertising content on the one or more digital signages.

### CROSS REFERENCES TO RELATED APPLICATIONS

None

### STATEMENT REGARDING FEDERALLY SPONSORED RESEARCH OR DEVELOPMENT

None.

### REFERENCE TO SEQUENTIAL LISTING, ETC.

None.

### BACKGROUND

### 1. Technical Field

The present invention relates generally to a system and methods of delivering targeted advertising through digital signages. Specifically, the present invention refers to a system and methods for delivering advertisements customized for or tailored to an audience within a substantial proximity or in a viewing range from one or more digital signages.

### 2. Description of the Related Art

Digital signage advertising uses LCD, LED, plasma, and other forms of projected displays to show multimedia content such as advertisements, news, and announcements in public venues such as malls, restaurants, and other retail locations. Current digital signage advertising solutions broadcast generic content and/or advertisements whether the content is relevant to the audience or not. Such content is static or non-responsive, i.e., the content does not change in response to a viewer's preferences or interests. No technology currently exists that allows advertisers to utilize digital signages for targeted advertising.

Targeted advertising is a type of advertising wherein advertisements are served to an audience so as to reach potential customers based on information relevant to such customers. Such information may include demographics, observed web browsing behavior, browsing history, purchase history, among others. Targeted advertising helps improve identification of potential customers and increase advertisers' return on investment (ROI) by providing specific advertising material to an audience who may be potential consumers of a product or a service instead of providing generic advertising material directed to the general population.

Thus, there is a need for a real-time method for distributing advertisements to digital signages that are tailored to the audience in front of or at an optimal proximity from the digital signages. There is also a need for a system and method for dynamically selecting and playing advertisements in digital signages according to the audience in the immediate viewing area of the signages instead of selecting and displaying generic advertisements.

### SUMMARY

A system and methods for delivering targeted advertising content to an audience of one or more digital signages are disclosed. One example method of delivering targeted advertising content includes receiving a network access request from a user of a client device located in a vicinity of the one or more digital signages. A permission to retrieve data from the client device may be requested from the user of the client device, and upon receiving the permission from the user, data from the client device may be retrieved. The example method further includes transmitting the retrieved data to an advertising server for determining by the advertising server one or more advertising content related to the retrieved data for displaying on the one or more digital signages. The one or more advertising content may then be received from the advertising server and displayed on the one or more digital signages.

From the foregoing disclosure and the following detailed description of various example embodiments, it will be apparent to those skilled in the art that the present disclosure provides a significant advance in the art of delivering targeted advertising content to an audience of one or more digital signages. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows an example system for delivering targeted advertising content to one or more users through a digital signage.

FIG. 2 shows an example method for intelligently selecting and displaying the most appropriate advertising content to an audience within close proximity to a digital signage in real time.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, may be implemented by special purpose hardware-based computer systems that perform the specified functions or steps or combinations of special purpose hardware and computer instructions.

Disclosed are a system and methods for delivering targeted advertising content to an audience of one or more digital signages. In one example embodiment of the present disclosure, the method may include receiving a request to access a network from a user of a client device located in a vicinity of the one or more digital signages. In response to the receiving of the request, a permission to retrieve data from the client device may be requested from the user of the client device, and upon receiving permission from the user, granting the client device permission to access the network and retrieving the data from the client device.

For purposes of the present disclosure, it will be appreciated that advertisements, advertising content, and advertising material may be referred to interchangeably in the present disclosure. Advertisements may refer to files such as, for example, image files, audio files, video files, and/or other documents containing information about a product or service.

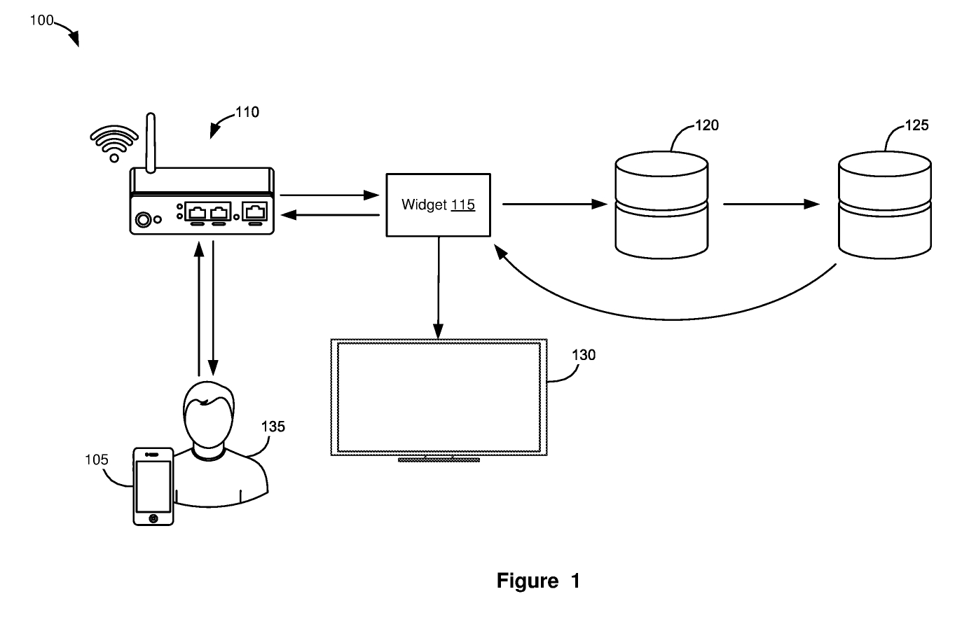

FIG. 1 shows an example system 100 for delivering targeted advertising content to one or more users through a digital signage. System 100 includes a client device 105 for connecting to a wireless access point 110. Wireless access point 110 may be communicatively connected to an application or widget 115 that communicates with a central server 120 and an advertising server 125. Widget 115 may also be communicatively connected to a digital signage 130 that provides digital signage advertisement space in a location such as, for example, a retail location or a public space.

Client device 105 may be any computing device such as a personal computer, a laptop computer, a workstation computer, or a mobile computing device having a data storage medium (not shown) for storing executable instructions, a processor for executing instructions, and a wireless communication function for connecting to a network. Client device 105 can scan various Wi-Fi channels or frequencies to detect signals from nearby access points. Client device 105 may be operated by a customer or user 135 and may include one or more installed applications that contain information regarding user 135 such as, for example, applications for searching content on the web that store the user's search history, web browsers, or social media applications containing personal information about the user.

Wireless access point 110 may be a communication device that allows one or more client devices including client device 105 to connect to a wired network such as, for example, the Internet. Wireless access point 110 may be connected to a router and may provide wireless access to a wired Ethernet network. Wireless access point 110 may be any device that is connected to a switch, hub or wireless router and broadcasts wireless signals that enable devices to connect to the wired network wirelessly. In one example embodiment, wireless access point 110 may be situated in a public area such as restaurants, malls, museums, etc., and may send out wireless signals to devices such as client device 105 that are within close proximity or are being used by users that are facing or are within substantially close proximity to one or more signages such as digital signage 130.

When client device 105 attempts to connect to the network through wireless access point 110, user 135 may be presented with a captive portal (not shown) via widget 115 that the user views and interacts with before access to the network may be granted. The captive portal may be a landing web page that requests one or more credentials from the user before allowing the user to gain access to the wired network. In another example embodiment, the captive portal may request permission from the user to access and/or collect data from client device 105. The collected data may be used to generate and deliver targeted advertisements to be displayed in digital signage 130, as will be described in greater detail below. After being redirected to the capture portal or web page, which may require acceptance of use policies and/or end user license agreements, authentication, payment, and other valid credentials that the user agrees to, the user may then be granted Internet access.

In one example embodiment, the captive portal may be provided by widget 115. Widget 115 may be an application stored locally at a gateway of wireless access point 110. In another example embodiment, widget 115 may be stored at a web server communicatively connected with wireless access point 110. Widget 115 may be connected in between wireless access point 110 and the network that user 135 wishes to connect to such that user 135, upon attempting to connect to the Internet using wireless access point 110, may interface and/or communicate with widget 115 prior to being granted access to the Internet.

Widget 115 may include one or more instructions for retrieving data from client device 105. User 135 may authorize widget 115 to collect data from one or more applications installed in client device 105 such as, for example, web browser search history, social media information, device identifying information, other user and/or device data, and send the collected data to central server 120. In some example embodiments, user 135 may grant widget 115 permission to access and/or retrieve information from client device 105 by agreeing to terms and conditions that are presented by widget 115 to user 135 when user 135 attempts to connect to the Internet.

In one example embodiment, widget 115 collects data from the one or more applications installed in client device 105 while client device 105 is connected to the Internet via wireless access point 110. In other example embodiments, widget 115 collects data while user interacts with client device 105. In yet other example embodiments, widget 115 may monitor the network behavior of client device 105 and retrieve information that is accessed by client device 105 while being connected to the Internet via wireless access point 110.

Central server 120 may be a computing server that receives and stores the user data from widget 115 and sends the user data to advertising server 125 for generation of ads that will be tailored based on the collected user data. In one example embodiment, central server 120 may receive user data collected from multiple wireless access points from a plurality of locations that utilize the present invention. For example, central server 120 may act as an agent for all communications between advertising server 125, and a plurality of widgets belonging to local networks of various locations or organizations.

In one alternative example embodiment, widget 115 may directly transmit data retrieved from client device 105 to advertising server 125. Advertising server 125 may be a web server that stores advertising content and delivers the content onto various digital platforms such as, for example, digital signage 130. Advertising server 125 may be managed by an advertiser or an advertising company that provides a service that places advertisements on digital signages. Advertising server 125 may be communicatively connected with central server 120. In one example embodiment, advertising server may be communicatively connected with a local network comprising widget 155, wireless access point 110, and digital signage 130.

In still other example embodiments, central server 120 and advertising server 125 may be a combined into a single server.

Advertising server 125 may receive the collected user data from central server 120 and determine the most appropriate advertising material to display on digital signage 130 based on the collected user data by applying known data analytics methods and techniques to identify data of particular interest to such user. In one example embodiment, advertising server 125 may include one or more advertising content ranging from one or more topics and send the most relevant advertising content to central server 120 which may then be sent to digital signage 130 for displaying.

In some alternative example embodiments, central server 120 may determine the most appropriate advertising material. In such example embodiments, central server 120 requests the desired advertising content from advertising server 125 after analyzing the collected user data.

Digital signage 130 may be any form of display monitor such as, for example, LED, LCD, or projection, that may be programmed to display content such as video, digital images, and other forms of multimedia. Digital signage 130 may also display streaming media that is continuously received from a server such as advertising server 125. Typically, digital signage 130 is displayed to an audience in public places such as restaurants, malls, museums, and other locations for informational and advertising purposes. Digital signage 130 typically includes a computing device or a playback device that is connected to a large digital screen. Digital signage 130 may be communicatively connected to at least one of central server 120, widget 115, and advertising server 125.

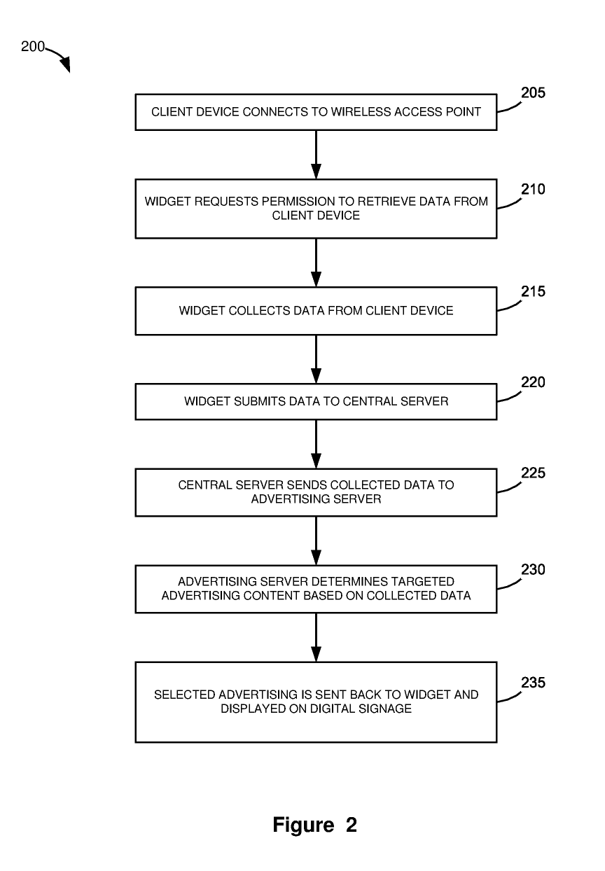

FIG. 2 shows one example method 200 for intelligently selecting and displaying targeted advertising material to an audience within close proximity to a digital signage in real time in the example system of FIG. 1. Example method 200 may include receiving a request from 105 client device to connect to a network via wireless access point 110, collecting data from client device 105 connected to the network via wireless access point 110, sending the collected data to central server 120, receiving targeted advertising material based on the collected data, and displaying the targeted advertising material on digital signage 130. Example method 200 may be performed by system 100 to serve tailored advertising content for displaying on digital signage 130 such that the advertising content is targeted and/or more relevant to the audience of digital signage 130.

At block 205, client device 105 connects to the network via wireless access point 110. In some example embodiments, user 135 may utilize client device 105 to connect to the network by searching for available wireless network connections, choosing the network provided by wireless access point 110, and requesting access to the network. In other example embodiments, client device 105 may automatically connect to wireless access point 110 when client device 105 is in range.

At block 210, widget 115 may request permission from user 135 to retrieve data from client device 105. In some example embodiments, widget 115 may request permission to access and retrieve data from client device 105 in exchange for granting user 135 access to the network by including such permission request in the network access terms and conditions. In such instances, if user 135 accepts such terms and conditions, widget 115 is authorized to and may access data in client device 105, and client device 105 may connect to the network or Internet.

In other example embodiments, widget 115 may request authorization to access data in client device 105 using other methods, such as by requesting access via electronic mail or in connection with a client device download request for a mobile application that is associated with the establishment in which digital signage 130 is located.

At block 215, widget 115 may continuously monitor and/or retrieve data from client device 105 while client device 105 is connected to the internet. Data retrieved from client device 105 may include user and/or device related information such as, for example, device identifiers, web search history, browsing history, user information from applications, user information from social media applications, and network behavior while client device 105 is connected to the network via wireless access point 110. In one example embodiment, widget 115 may also access available geo-location or GPS information of client device 105 to identify the most accurate position of customer 135 in the business location (e.g., restaurant) in order to determine the nearest digital signage 130 where the tailored advertising material may be displayed.

At block 220, widget 115 may submit at least one of the collected user data and the device information to central server 120. In one example embodiment, central server 120 may receive and manage collected user and device information from a plurality of widgets 115 in multiple local networks. In one example embodiment, widget 115 may send the data to central server 120 once the data has been retrieved. In other example embodiments, widget 115 may send the collected data to central server 120 as the data is generated at client device 105.

In yet other example embodiments, widget 115 may continuously collect user data from client device 105 while client device 105 is connected to the Internet and continuously send the collected user data to central server 120, which then sends the collected user data to advertising server 125 so that digital signage 130 may show real-time targeted or tailored advertising content while user 135 is connected to the Internet via wireless access point 110 and while user 135 is within viewing range or in an optimal proximity to digital signage 130. For example, widget 115 may monitor network behavior and when widget 115 detects that user 135 performed a web search using client device 105, widget 115 may retrieve information relating to the web search and send the retrieved information to central server 120. In still other example embodiments, widget 115 may collect user data and send the collected data to central server 120 at predefined time and intervals.

At block 225, central server 120 sends the retrieved data to advertising server 125. At block 230, advertising server 125 determines the advertising content that should be displayed on digital signage 130. Advertising server 125 may determine the appropriate advertising content based upon the retrieved customer and/or device data through one or more targeted advertising techniques, such as, for example, selecting the advertising content based on demographic traits of user 130 such as, for example, age, gender, race, economic status, income level, employment, level of education, location of user 130, among others. Other traits that are based on the user's attitudes, opinions, interests, personality, and lifestyle may also be considered. Other data analytics methods for identifying the most appropriate advertising content to return to central server 120 based on the information retrieved from client device 105 will be known in the art.

Once advertising server 125 has identified the targeted advertising content based on the retrieved data, the targeted advertising content is then sent to widget 115 at block 235. Widget 115 then communicates the targeted advertising content to digital signage 130, which displays the targeted advertising content. In some alternative example embodiments, advertising server 125 transmits the targeted advertising content to central server 120 which then communicates the targeted advertising content to digital signage 130 for displaying.

In one example application of example method 200, a user 135 may be searching for information regarding a movie while at a mall or movie theater. Widget 115 may detect the browsing behavior on client device 105 and retrieve related information such as, for example, the title of the movie being searched. Widget 115 may then send the retrieved information to central server 120. Central server 120 may then send the title of the movie and/or other retrieved information to advertising server 125. Advertising server 125 may determine and/or generate an advertisement relating to the title of the movie such as, for example, screening times in theaters that are near the location of user 135. Advertising server 125 then sends or transmits to widget 115 the generated advertising content relevant to the browsing behavior of user 130. Widget 115 may then transmit the generated advertising content to digital signage 130, which displays the tailored advertisement.

This example digital signage system and method of targeted advertising communicates more effective advertising materials to potential customers in real-time. In some example aspects, when widget 115 continuously monitors the activities on client device 105, the advertisements displayed on digital signage 130 may be automatically updated to reflect the new topic that the user is interested in when the browsing activities of user 135 change such as, for example, when user 135 searches a new topic. In other example aspects, where user 135 is not actively browsing or searching for content on the web, widget 115 may utilize other information that may be retrieved from client device 105 to identify relevant advertising content. Such the other information may include, for example, the interests of user 135 as indicated or posted in social media applications, the browsing or purchasing history of user made on one or more applications on client device 105, the location of the user, and/or the brand and/or model of client device 105, among others.

In some example embodiments, system 100 may include multiple client devices 105 communicating with widget 115. When a plurality of client devices 105 are connected to the Internet via wireless access point 110, widget 115 may collect data from each of client devices 105 and send all of the collected data to central server 120. A plurality of advertisements may be returned by advertising server 125 and may be displayed in a predefined order such as, for example, advertisements that relate to user 135 who connected to the network first may be displayed first. In some example aspects, advertising server 125 may analyze the data collected from each of client devices 105 and transmit advertising content relevant to the group of users 135 directly or indirectly to digital signage 130 for display.

An advertisement may be displayed or included in a loop of advertisements displayed on digital signage 130 as long as user 135 is determined to be connected to the Internet via wireless access point 110. If user 135 is identified as no longer being connected to the Internet via wireless access point 110 such as, for example, when the user has left the premises, widget 115 may control display signage 130 by ceasing to displaying the tailored advertisement. In another example embodiment, a tailored advertisement may automatically expire such that it will no longer be shown on display signage 130 after a predetermined amount of time or after a predetermined amount of time that user 135 is longer connected to the Internet.

In one alternative example embodiment of the present disclosure, digital signage system 100 may be used in a residential setting wherein widget 115 monitors Internet usage in a home connection of user 135. In such systems, customized advertising content based upon the network activity of user 135 using the home Internet connection may be shown on display devices, such as smart televisions, found in the residence of user 135. In such example embodiment, widget 115 may collect data from each of client devices 105 in the home, and send all of the collected data to central server 120. Advertising server 125 may return a plurality of customized advertisements to be shown on the display devices in the residential setting. In this example embodiment, widget 115 may be managed by an internet service provider which may offer rebates to user 135 in exchange for user having viewed the tailored advertisements.

It will be understood that the example applications described herein are illustrative and should not be considered limiting. It will be appreciated that the actions described and shown in the example flowcharts may be carried out or performed in any suitable order. It will also be appreciated that not all of the actions described in FIG. 2 need to be performed in accordance with the example embodiments of the disclosure and/or additional actions may be performed in accordance with other example embodiments of the disclosure.

Many modifications and other example embodiments of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of delivering targeted advertising content to an audience of one or more digital signages, comprising:
receiving a network access request from a user of a client device located in a vicinity of the one or more digital signages;
requesting permission from the user of the client device to retrieve data from the client device;
upon receiving the permission from the user, retrieving the data from the client device;
transmitting the retrieved data to an advertising server for determining one or more advertising content based upon the retrieved data;
receiving the one or more advertising content from the advertising server; and
rendering the one or more advertising content on the one or more digital signages.

2. The method of claim 1, further comprising allowing the client device to connect to the network upon the receiving the permission from the user.

3. The method of claim 1, wherein the retrieving the data from the client device is performed while the client device is connected to the network.

4. The method of claim 1, further comprising monitoring activities performed in the client device while the client device is connected to the network.

5. The method of claim 4, wherein the retrieving the data from the client device includes retrieving information based upon the activities being performed in the client device while the client device is connected to the network.

6. The method of claim 1, wherein the retrieving the data from the client device includes retrieving web search information from one or more applications installed in the client device.

7. A computing device having a non-transitory computer readable storage medium containing one or more instructions for delivering targeted advertising materials to an audience of one or more digital signages, the one or more instructions comprising an instruction to:
receive a request to connect to a network from a user of a client device located in a vicinity of the one or more digital signages;
prior to granting the user of the client device connection to the network, request permission from the user of the client device to retrieve information from the client device;
retrieve information from the client device upon receiving the permission from the user and while the client device is connected to the network;
transmit the retrieved information to an advertising server for determining one or more tailored advertising materials based upon the retrieved information; and
receive the one or more tailored advertising materials from the advertising server for display on the one or more digital signages.

8. The computing device of claim 7, wherein the display of the one or more tailored advertising materials is displayed for a predefined amount of time.

9. The computing device of claim 7, wherein the display of the one or more tailored advertising materials is displayed while the client device is connected to the network.

10. The computing device of claim 7, wherein the instruction to retrieve the information from the client device includes retrieving information relating to the network behavior in the client device.

11. The computing device of claim 7, further comprising an instruction to continuously monitor network behavior of the client device.

12. The computing device of claim 11, wherein the instruction to continuously monitor the network behavior of the client device includes an instruction to determine if the user of the client device performed a web search.

13. The computing device of claim 12, further comprising one or more instructions to:
retrieve information relating to the web search upon a positive determination that the user of the client device performed the web search; and
transmit the retrieved web search information to the advertising server, wherein the determining the one or more tailored advertising materials is based upon the information relating to the web search.

14. The computing device of claim 7, wherein the instructions to retrieve information from the client device and transmit the retrieved information to the advertising server are continuously performed such that one or more changes in a network behavior of the client device are identified and transmitted to the advertising server, and the advertising server determines tailored advertising materials based upon the one or more changes in the network behavior.

15. The computing device of claim 7, wherein the instruction to retrieve the information relating to the user of the client device includes an instruction to retrieve information from one or more social media applications installed on the client device.

16. A system for delivering advertising content to an audience of a digital signage, the system comprising:
a network comprising:
a client device utilized by a user for requesting network access;
a wireless access point that receives the network access request from the client device;
an application communicatively connected with the wireless access point that sends to the user of the client device a request for permission to retrieve information from the client device prior to granting the client device access to the network; and
the digital signage located in substantially close proximity to the user of the client device;
a central server connected to the network; and
an advertising server communicatively connected with the central server that stores one or more advertising content,
wherein upon the user of the client device granting the application the permission to retrieve the information from the client device and while the client device is connected to the network, the application retrieves the information from the client device and sends the retrieved information to the central server and wherein the central server sends the retrieved information to the advertising server, and wherein the advertising server determines targeted advertising content based on the retrieved information and returns the targeted advertising content to the application for rendering on the digital signage.

17. The system of claim 16, wherein the application determines if the client device is requesting the network access, and upon a positive determination, the application sends the request for permission to the user of the client device to retrieve the information from the client device.

18. The system of claim 16, wherein the advertising server returns the targeted advertising content to the central server.

19. The system of claim 18, wherein the central server transmits the targeted advertising content to the application and the application sends the targeted advertising content to the digital signage located in substantially close proximity to the user.

20. The system of claim 16, wherein the digital signage displays the targeted advertising content while the client device is connected to the network.
